(19) United States
(12) Patent Application Publication
(10) Pub. No.: US 2025/0138158 A1
(43) Pub. Date: May 1, 2025

(54) LIGHT PROJECTION DEVICE, LIGHT PROJECTION-AND-RECEPTION APPARATUS, AND DISTANCE MEASUREMENT SYSTEM

(71) Applicants: Soya HATAZAKI, Kanagawa (JP); Hiroyuki SATOH, Kanagawa (JP)

(72) Inventors: Soya HATAZAKI, Kanagawa (JP); Hiroyuki SATOH, Kanagawa (JP)

(21) Appl. No.: 18/890,993

(22) Filed: Sep. 20, 2024

(30) Foreign Application Priority Data
Oct. 31, 2023 (JP) 2023-186763

(51) Int. Cl. G01S 7/481; G01S 17/08

(52) U.S. Cl. CPC G01S 7/4814; G01S 17/08

(57) ABSTRACT

A light projection device includes a light source to emit light, and an optical system to project pattern light to an object. The pattern light is obtained from the light emitted from the light source. The optical system includes a first lens group on which the light emitted from the light source incident, the first lens group having a positive power, an optical element to form the pattern light from the light passing through the first lens group and incident on the optical element, and a second lens group on which the pattern light emitted from the optical element incident, the second lens group having a positive power. The second lens group includes a third lens group having a positive power, and a fourth lens group having a negative power.

### CROSS-REFERENCE TO RELATED APPLICATIONS

This patent application is based on and claims priority pursuant to 35 U.S.C. § 119 (a) to Japanese Patent Application No. 2023-186763, filed on Oct. 31, 2023, in the Japan Patent Office, the entire disclosure of which is hereby incorporated by reference herein.

### BACKGROUND

### Technical Field

Embodiments of the present disclosure relate to a light projection device, a light projection-and-reception apparatus, and a distance measurement system.

### Related Art

In the related art, a light projection device that projects pattern light (e.g., a dot pattern) to an object is known. In such a light projection device, for example, the pattern light can be projected over a wide range using an optical system having a wide angle of view.

When the optical system of the light projection device in the related art has a wide angle of view, a larger aberration occurs in a region in which the angle from the optical axis of the optical system is larger, and the area of a spot projected to an object (e.g., the area of dot light) increases. In the related art, there is room to prevent the area of the spot projected to the object from increasing.

### SUMMARY

According to an embodiment of the present disclosure, a light projection device includes a light source to emit light and an optical system to project pattern light to an object. The pattern light is obtained from the light emitted from the light source. The optical system includes a first lens group on which the light emitted from the light source incident, the first lens group having a positive power, an optical element to form the pattern light from the light passing through the first lens group and incident on the optical element, and a second lens group on which the pattern light emitted from the optical element incident, the second lens group having a positive power. The second lens group includes a third lens group having a positive power and a fourth lens group having a negative power, and the third lens group and the fourth lens group are arranged in order of the third lens group and the fourth lens group from the optical element.

According to an embodiment of the present disclosure, a light projection-and-reception apparatus includes the light projection device to project the pattern light to the object, a light receiver to receive a reflection light reflected from the object to which the pattern light is projected, and circuitry to control the light source and the light receiver.

According to an embodiment of the present disclosure, a measurement system includes the light projection-and-reception apparatus and circuitry to calculate a distance to the object based on an output of the light received by the light receiver.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a block diagram of a configuration of a distance measurement system according to a first embodiment;

FIG. 2 is a block diagram of a configuration of a light projection-and-reception unit according to the first embodiment;

FIG. 3 is a diagram illustrating a light projection-and-reception apparatus that projects and receives light by time of flight, according to the first embodiment;

FIG. 4 is a schematic diagram illustrating an example of an implementation of a light projection-and-reception apparatus;

FIG. 5 is a schematic diagram illustrating an example of an implementation of a light projection device;

FIG. 6 is a diagram illustrating an afocal-system converter that widens the angle of view, according to a comparative example;

FIG. 7 is a diagram illustrating an optical configuration of a light projection unit;

FIG. 8A is a diagram illustrating the optical path of a collimation type;

FIG. 8B is a diagram illustrating the optical path of a divergence type;

FIG. 9 is a diagram illustrating power distributions of collimation types and divergence types;

FIG. 10A is a diagram illustrating lateral aberration of multiple optical designs;

FIG. 10B is a diagram illustrating lateral aberration of multiple optical designs;

FIG. 10C is a diagram illustrating lateral aberration of multiple optical designs;

FIG. 10D is a diagram illustrating lateral aberration of multiple optical designs;

FIG. 11 is a diagram illustrating dot-pattern light of multiple optical designs;

FIG. 12 is an optical configuration of a light projection unit according to a modification;

FIG. 13 is a diagram illustrating another example of the configuration of optical components in the light projection-and-reception apparatus;

FIG. 14 is a block diagram of a configuration of a three-dimensional shape generation system according to a second embodiment;

FIG. 15 is a diagram illustrating an example of a portable information terminal to which the distance measurement system according to the first embodiment is applied; and

FIG. 16 is a diagram illustrating an example of an autonomous moving system of a mobile object to which the distance measurement system according to the first embodiment is applied.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

According to an embodiment of the present disclosure, a light projection device, a light projection-and-reception apparatus, and a distance measurement system are provided that can prevent an area of the light projected to the object from increasing even when an optical system has a wide angle of view.

In the following description, a first embodiment of the present disclosure will be described with reference to the drawings. In the following description, like reference signs denote like elements, and redundant description is appropriately simplified or omitted.

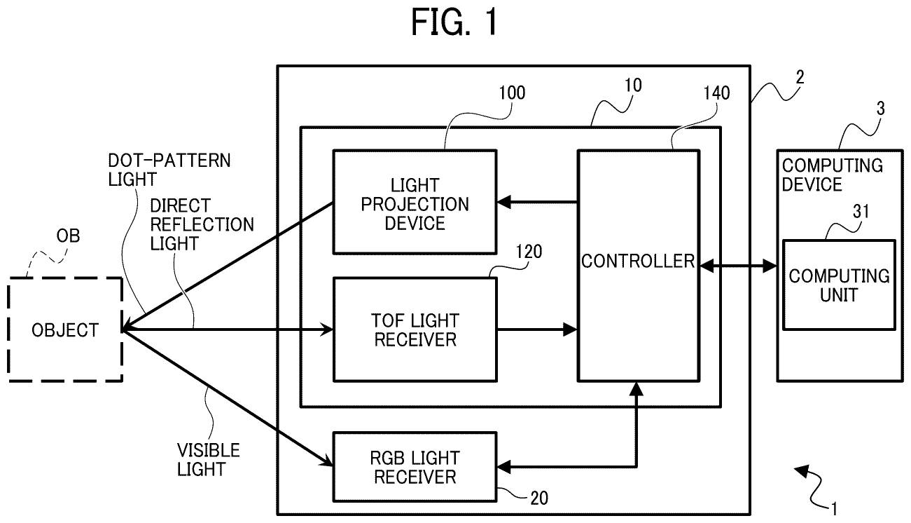

FIG. 1 is a block diagram of a configuration of a distance measurement system 1 according to a first embodiment.

As illustrated in FIG. 1, the distance measurement system 1 includes a light projection-and-reception apparatus 2 and a computing device 3 (an example of circuitry).

The distance measurement system 1 according to the present embodiment is a system to measure the distance from the light projection-and-reception apparatus 2 to an object (referred to as “object OB”) by a time of flight (ToF) method. In the ToF method, the object OB is irradiated with distance measurement light (e.g., laser beam) having a wavelength different from the wavelength of visible light. The distance to each portion (i.e., each irradiation position) of the object OB is calculated based on the time difference between the emission timing and the reception timing of the laser beam at each irradiation position.

In the present embodiment, a diffraction optical element is used in a light projection optical system that projects the laser beam. When a pattern light such as a dot pattern is projected to the object OB using a diffractive optical element, point group data with high brightness and high density can be obtained. The diffractive optical element is referred to as a diffractive optical element (DOE) below.

The light projection-and-reception apparatus 2 includes a light projection-and-reception unit 10 and a red-green-blue (RGB) light receiver 20. The “light projection-and-reception apparatus” may be alternatively referred to as a “light projection device,” an “imaging device,” or a “distance measurement device.”

The light projection-and-reception apparatus 2 includes, for example, a rechargeable battery. In other words, the light projection-and-reception apparatus 2 is driven by a battery. The light projection-and-reception apparatus 2 may be also driven by a commercial power supply.

The light projection-and-reception unit 10 includes a light projection device 100, a ToF light receiver 120, and a controller 140.

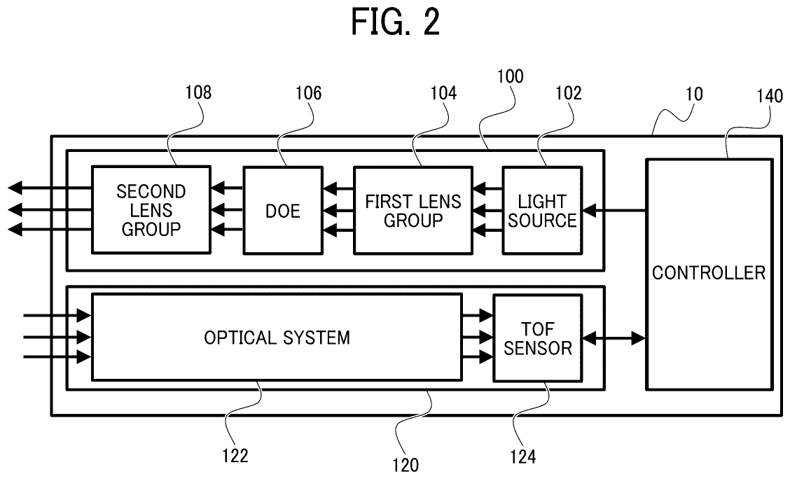

FIG. 2 is a block diagram of the light projection-and-reception unit 10.

The light projection device 100 projects the pattern light to the object OB. As illustrated in FIG. 2, the light projection device 100 includes a light source 102, a first lens group 104, a DOE 106, and a second lens group 108.

The controller 140 controls the light projection device 100 and the ToF light receiver 120. Specifically, the controller 140 (an example of circuitry) includes a central processing unit (CPU), a light source driving circuit, an imaging signal processing circuit, an input-and-output circuit, and a memory as a circuit configuration.

The controller 140 is, for example, a single processor or a multiprocessor, and includes at least one processor. In the case of the configuration including multiple processors, the controller 140 may be packaged as a single device, or may be physically separated into multiple devices in the light projection-and-reception unit 10.

The light source 102 is an example of a light source that emits at least one light beam. The light source 102 is, for example, a laser diode (LD) to emit a laser beam. The light source 102 emits a light beam at a predetermined timing controlled by the controller 140.

The first lens group 104, the DOE 106, and the second lens group 108 are examples of components in an optical system that projects pattern light obtained from the laser beam emitted from the light source 102 to an object.

The first lens group 104 is an example of the first lens group. The laser beam emitted from the light source 102 goes in the first lens group 104.

The DOE 106 is an example of an optical element that obtains pattern light from the laser beam that goes in the DOE 106 through the first lens group 104. In other words, the DOE 106 generates pattern light. The DOE 106 emits, for example, pattern light in which multiple dots are arranged in a lattice (referred to as “dot-pattern light” below).

The second lens group 108 is an example of the second lens group. The dot-pattern light emitted from the DOE 106 goes in the second lens group 108. The second lens group 108 projects the dot-pattern light to the object OB.

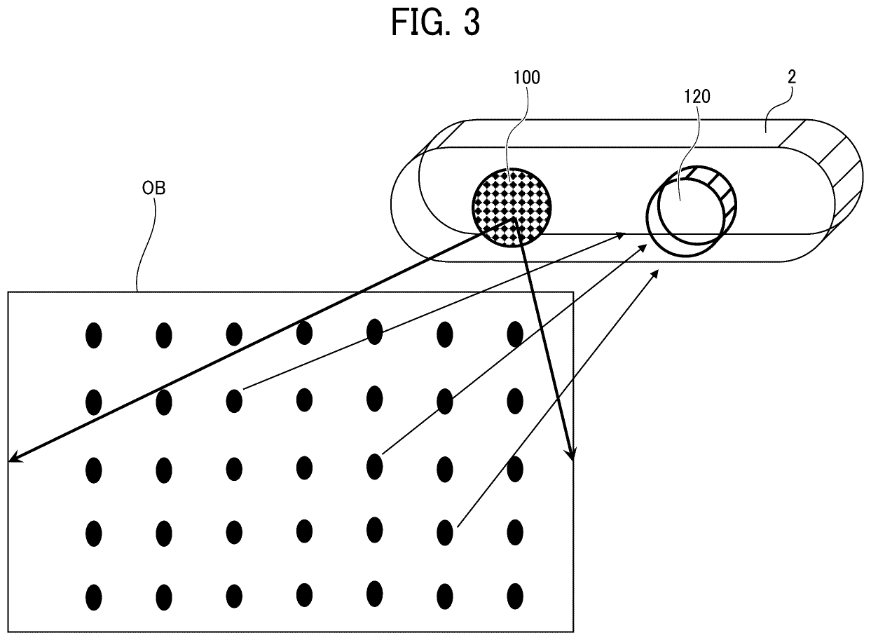

FIG. 3 is a diagram illustrating an example of ToF imaging by the light projection-and-reception apparatus 2. In FIG. 3, the RGB light receiver 20 is omitted for convenience.

As illustrated in FIG. 3, the light projection-and-reception apparatus 2 projects the dot-pattern light to the object OB. In order to project such pattern light, for example, a vertical cavity surface emitting laser (VCSEL) having multiple light emitting portions arranged in a pattern is used as the light source 102, a dot pattern is generated by diffraction of the DOE 16 having a fine structure, or a combination of the VCSEL and the DOE 16 is used. Accordingly, the dot-pattern light with high brightness and high density can be projected to the object OB, and the distance measurement accuracy is increased.

Specifically, the case where the diffraction pattern of the DOE 106 is formed in a dot pattern will be described below. In this case, the light source 102 is a point light source such as an LD. The laser beam emitted from the light source 102 goes in the DOE 106 through the first lens group 104.

When the laser beam goes in the DOE 106, conjugate points having the number corresponding to the diffraction order (0th order, +1st order, +2nd order, . . . ) of the DOE 106 occur, and the dot-pattern light corresponding to the diffraction order is emitted to infinity.

When the VCSEL and the DOE 106 are used in combination, a wide region can be irradiated with the dot-pattern light.

The dot-pattern light emitted to the object OB is reflected or scattered by the object OB. The ToF light receiver 120 receives the light directly reflected by the object OB (referred to as “direct reflection light”).

The ToF light receiver 120 is an example of a light receiver that receives the reflection light from the object OB to which the dot-pattern light is projected. As illustrated in FIG. 2, the ToF light receiver 120 includes the optical system 122 and the ToF sensor 124.

The optical system 122 includes, for example, an aperture, an imaging optical system, and a filter. The direct reflection light reflected from the object OB irradiated with the dot-pattern light passes through the optical system 122 and is received by the ToF sensor 124.

The ToF sensor 124 is an imaging element such as a complementary metal-oxide semiconductor (CMOS) image sensor, and photoelectrically converts the sum of exposure amounts during multiple exposure periods that that are the predetermined phase difference to the irradiated light into an electrical charge to output the converted data to the controller 140.

The light reception data output by the ToF sensor 124 is input into the computing device 3 via the controller 140.

The computing unit 31 (an example of circuitry) of the computing device 3 is implemented by a command from the CPU of the computing device 3, and calculates the distance to each portion (i.e., each irradiation position) of the object OB based on the sum of the exposure amounts during each exposure period input from the ToF sensor 124. The computing unit 31 may calculate the distance based on the time difference between the emitting timing of the laser beam (i.e., the light emission timing of the light source 102) and the reception timing of the laser beam (i.e., the input timing from the ToF sensor 124) at each irradiation position using a single photon avalanche diode (SPAD) as the ToF sensor 124.

In other words, the computing unit 31 of the computing device 3 is an example of a distance calculator that calculates the distance to the object OB based on the output of the light reception by the ToF light receiver 120.

The RGB light receiver 20 includes, for example, an aperture, an imaging optical system, a filter, and an image sensor. The image sensor is, for example, a CMOS image sensor, and includes an RGB color filter.

The image sensor may be replaced with another type of image sensor such as a charge coupled device (CCD) image sensor. The image sensor may include a complementary color filter having a checkered pattern.

The image sensor is driven under the control of the controller 140 and receives visible light (i.e., natural light) on the light reception surface. The image sensor accumulates the electric charges corresponding to the amount of light at each pixel of the light reception surface on which an optical image is formed, and outputs the electric charges at a timing synchronized with, for example, the time of flight (ToF) imaging. The controller 140 outputs RGB image data based on each pixel data to the computing device 3.

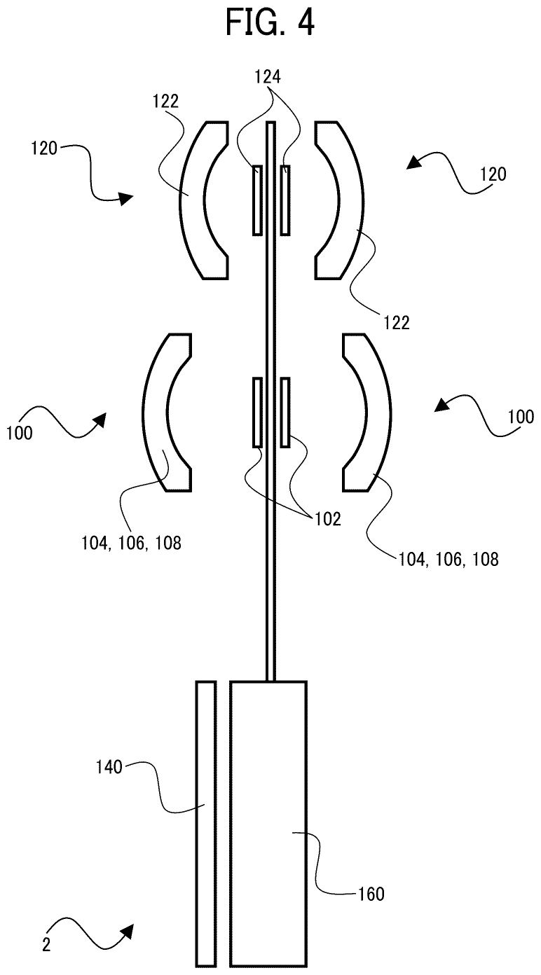

FIG. 4 is a schematic diagram illustrating an example of an implementation of the light projection-and-reception apparatus 2. In FIG. 4, the battery 160 drives the light projection-and-reception apparatus 2 In FIG. 4, the first lens group 104, the DOE 106, and the second lens group 108 are represented as one lens block for convenience.

In the example illustrated in FIG. 4, the light projection-and-reception apparatus 2 is configured as an apparatus that can take a full-spherical panoramic image. The full-spherical panoramic image is a panoramic image obtained by taking a photograph of the range of the full sphere obtaining an image within a solid angle of 4π steradians.

The light projection-and-reception apparatus 2 illustrated in FIG. 4 includes a pair of light projection devices 100 and a pair of ToF light receivers 120 each having a wide angle of view to image a hemispherical image. Similarly, the light projection-and-reception apparatus 2a includes a pair of RGB light receivers 20.

The pair of RGB light receivers 20 take image of an object (e.g., the object OB) around the light projection-and-reception apparatus 2. Accordingly, a pair of hemispherical images are obtained. The controller 140 combines the pair of hemispherical images to generate, for example, a full-spherical panoramic image expressed in Mercator projection.

The direct reflection light from the object OB irradiated with the dot-pattern light emitted from each of the pair of light projection devices 100 is received by the corresponding ToF light receiver 120. The computing device 3 calculates the distance to each portion (i.e., each irradiation position) of the object OB based on the time difference between the emission timing and the reception timing of the laser beam at each irradiation position. Since distance information corresponding to the pair of ToF light receivers 120 matches with each other, the distance information of the full-spherical range corresponding to the full spherical panoramic image is obtained. In other words, a three-dimensional point group that is an aggregate of coordinate points in a three-dimensional space can be obtained. Color information (e.g., RGB values of each coordinate point) may be added to each coordinate point of the point group.

In an example of the configuration illustrated in FIG. 1, the light projection-and-reception apparatus 2 includes the light projection-and-reception unit 10. As illustrated in FIG. 2, the light projection-and-reception unit 10 may be used as a single device independent of the light projection-and-reception apparatus 2.

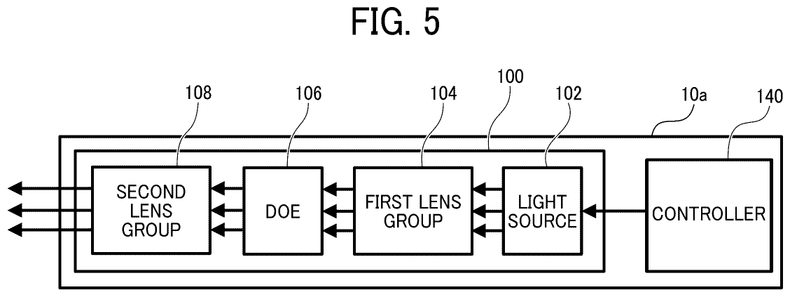

The light projection device 100 (i.e., the light projection unit) may be configured as a single device independent of the light projection-and-reception unit 10. FIG. 5 is a block diagram of the light projection unit 10a as a single device.

As illustrated in FIG. 5, the light projection unit 10a includes a light projection device 100 and controller 140. In other words, in an example of this configuration, the light projection unit 10a has a configuration excluding the ToF light receiver 120 from the light projection-and-reception unit 10 illustrated in FIG. 2.

The light projection unit 10a may not include the controller 140. In other words, the light projection unit 10a may be an optical device in which the light source 102, the first lens group 104, the DOE 106, and the second lens group 108 are arranged as optical components. In this case, for example, a signal sending component such as a cable is connected to a terminal disposed in the light projection unit 10a. As a result, the light source 102 and the controller 140 connected to the other end of the cable are connected to each other via the signal sending component.

In an example of the configuration illustrated in FIG. 1, the light projection-and-reception apparatus 2 includes the RGB light receiver 20. The light projection-and-reception apparatus 2 may not include the RGB light receiver 20.

The computing device 3 is, for example, a terminal device such as a personal computer (PC) or a server disposed at a cloud. The light projection-and-reception apparatus 2 and the computing device 3 can communicate with each other through wired communication or wireless communication via a sending-and-receiver disposed in the light projection-and-reception apparatus 2 and the computing device 3, respectively. The data may be sent (output) from the light projection-and-reception apparatus 2 to the computing device 3 via the network, or the sending-and-receiver may be configured by an interface circuit with a portable storage medium such as an SD card or a personal computer. In another embodiment, the light projection-and-reception apparatus 2 may include the computing unit 31. In this case, the computing unit 31 may be, for example, a processor included in the controller 140. The computing unit 31 may be configured as a processor independent of the controller 140.

As described above, since the configuration of each part of the distance measurement system 1 has a degree of freedom, various configurations can be designed.

A technology is known in which a converter of an afocal optical system (referred to as an afocal-system converter below) is combined with the projection optical system so that the projection angle of dot-pattern light is extended to 90 degrees or more at a half angle of view. However, in the afocal-system converter, since a larger aberration occurs in a region in which the angle from the optical axis is larger, the dot-pattern light is projected to the object in a widened state without being condensed at high density.

In other words, the area of the dot-pattern light is so widened that the brightness of the dot pattern light is decreased. In addition, since the area of the dot-pattern light is widened, it becomes difficult to maintain a sufficient distance between the dots in the dot-pattern light. As a result, it is difficult to obtain a sufficient distance measurement accuracy.

The light projection device 100 according to the present embodiment includes at least a first lens group 104 having a positive power and a second lens group 108 having a positive power. The second lens group 108 includes at least a third lens group 108a having a positive power and a fourth lens group 108b having a negative power, which are arranged in this order from the DOE 106 side.

The light projection device 100 may include other additional optical elements within the scope of the technical idea of the present disclosure. For example, a configuration including a parallel flat plate that does not substantially contribute to the optical performance of the light projection device 100 according to the present embodiment as an additional element, or a configuration that includes an additional element while maintaining the configuration and the effect of the light projection device 100 according to the present embodiment is assumed.

When such a configuration described above is applied to the light projection device, aberration can be corrected satisfactorily, and the area of the dot-pattern light can be prevented from spreading even in a region in which the angle from the optical axis is large. Since the area of the dot-pattern light is prevented from spreading (i.e., the convergence of the dot-pattern light is increased), the brightness of the dot-pattern light can be maintained, and the contrast is increased. As a result, the accuracy of the distance measurement is increased.

In addition, since the area of the dot-pattern light is prevented from spreading, a sufficient distance between dots in the dot-pattern light can be maintained. Thus, for example, calibration can be performed by utilizing the gap between dots in the dot-pattern light. Accordingly, the accuracy of the distance measurement can be increased.

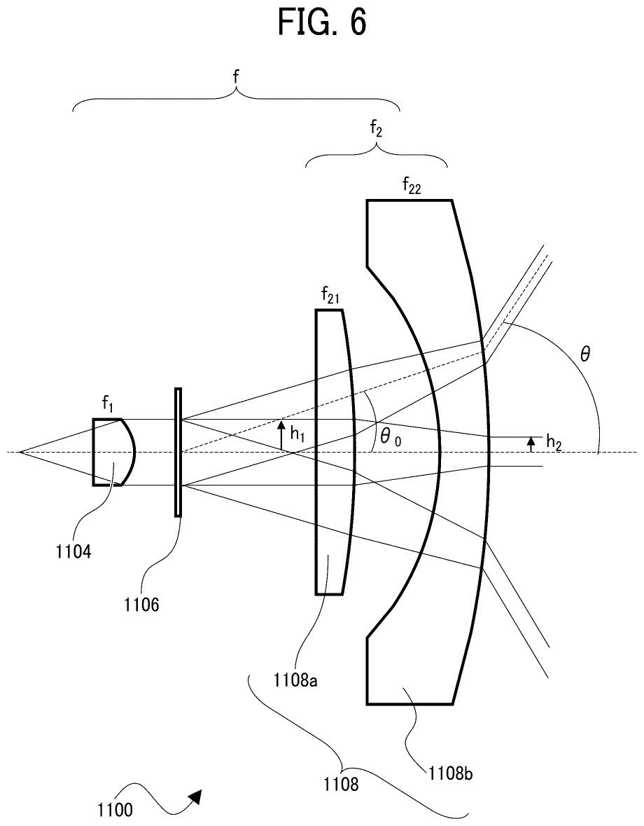

FIG. 6 is a diagram illustrating an afocal-system converter that widens the angle of view, according to a comparative example.

As illustrated in FIG. 6, a light projection unit 1100 according to a comparative example includes a first lens group 1104, a DOE 1106, and a second lens group 1108. The second lens group 1108 according to the comparative example is an afocal-system converter having substantially no power, and includes a third lens group 1108a having a positive power and a fourth lens group 1108b having a negative power, in order to widen the angle of view. The magnification m of the second lens group 1108 is expressed by the following equation:

$$m = θ / {θ}_{0} = {h}_{1} / {h}_{2} ,$$

where θ₀ is the angle of view of the ray diffracted by the DOE 1106 (degree),
θ is the angle of view of the ray (parallel light) emitted from the second lens group 1108 (degree),
h₁ is the height of the on-axis ray going in the third lens group 1108a (millimeter (mm)), and
h₂ is the height of the on-axis ray exiting from the fourth lens group 1108b (mm).

The magnification m is a ratio of the final optical surface of the light projection device 1100 (i.e., the final optical surface of the fourth lens group 1108b in FIG. 6 to the angle of view on the emitting surface of the DOE 1106.

Since the second lens group 1108 is an afocal-system converter and has no power, the formulae below are satisfied from the homothetic ratio.

$${f}_{21} : - {f}_{22} = {h}_{1} : {h}_{2}$$

$$m = {f}_{21} / - {f}_{22} ,$$

where f₁ is a focal length of the first lens group 1104 (mm),
f₂ is a focal length of the second lens group 1108 (mm),
f₂₁ is a focal length of the third lens group 1108a, and
f₂₂ is a focal length of the fourth lens group 1108b, and
f is a focal length of the entire light projection unit 1100.

The second lens group 1108 is a magnifying optical system that magnifies the angle of view, and since the magnification m exceeds 1, the formula below is satisfied.

$$\vert {f}_{21} \vert > \vert {f}_{22} \vert$$

As described above, in the case of the afocal-system converter (i.e., the combined power of the magnifying optical system is zero), the negative power of the fourth lens group 1108b is higher than the positive power of the third lens group 1108a.

The magnifying optical system that magnifies the half angle of view to 90 degrees or more is a fisheye lens. The higher-order diffraction light split by the DOE 1106 passes through the fisheye lens (i.e., the second lens group 1108) at a position at which the height from the optical axis is high. Thus, the diffraction light is strongly affected by astigmatism.

The first lens group 1104 disposed upstream from the DOE 1106 in the direction of travel of light does not have the aberration correction capability for the higher-order diffraction light split by the DOE 1106. Only the third lens group 1108a that is a positive lens group and is disposed downstream from the DOE 1106 in the direction of travel of light can correct astigmatism.

However, as described above, the third lens group 1108a has a lower power than the fourth lens group 1108b, and a lower aberration correction capability. In the second lens group 1108 that is an afocal-system converter, it is difficult to correct the astigmatism that occurs in the fourth lens group 1108b of a negative lens group having a high power by the third lens group 1108a of a positive lens group having a lower power.

For this reason, in the light projection device 100 according to the present embodiment, the power of the first lens group 104 is set such that the divergent light goes in the DOE 106. In other words, the light projection device 100 decreases the power of the first lens group 104 as compared with the case where the afocal-system converter is used. Further, in the light projection device 100, the power of the third lens group 108a with respect to the fourth lens group 108b is higher than the power of the afocal-system converter such that the astigmatism that occurs in the fourth lens group 108b is canceled. It is preferable that the power of the third lens group 108a with respect to the fourth lens group 108b is limited to such an extent that spherical aberration does not largely occur.

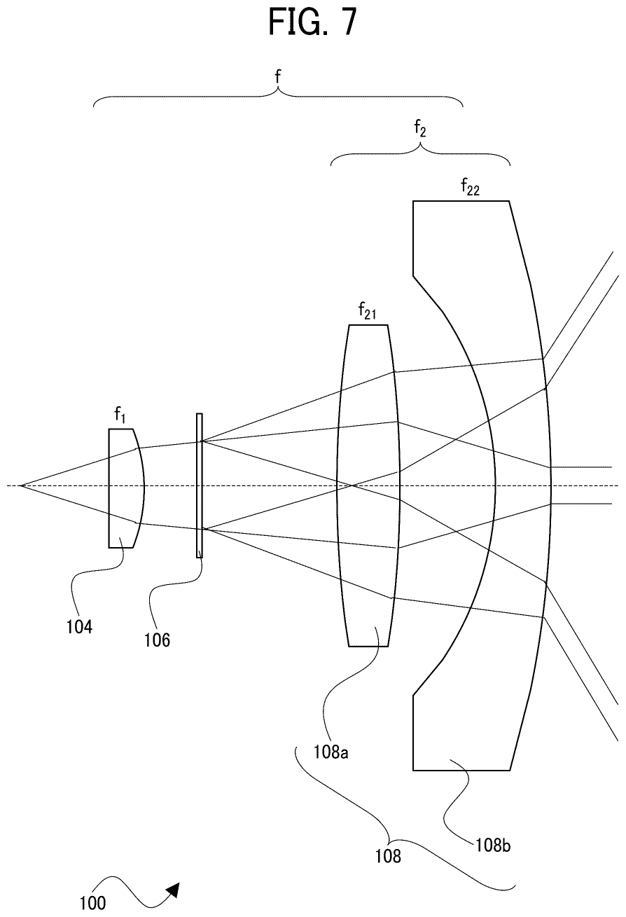

FIG. 7 is a diagram illustrating an optical configuration of the light projection device 100 according to the present embodiment. As illustrated in FIG. 7, since the power of the first lens group 104 in the light projection device 100 is decreased, the divergent light goes in the DOE 106. Accordingly, the positive power of the second lens group 108 can be increased, and the focal length f₂ of the second lens group 108 becomes positive. Thus, the aberration that occurs in the fourth lens group 108b, which is a negative lens group, is largely cancelled in the third lens group 108a. As a result, the convergence of the dot-pattern light is increased.

As described above, according to the present embodiment, aberration can be corrected satisfactorily, and the area of the dot-pattern light can be prevented from spreading even in a region in which the angle from the optical axis is large. Since the area of the dot-pattern light is prevented from spreading, the brightness of the dot-pattern light can be maintained, and the contrast is increased. As a result, the accuracy of the distance measurement is increased.

Since the light emitted from the DOE 106 is substantially parallel light, the second lens group 1108 that is an afocal-system converter according to a comparative example (e.g., see FIG. 6) may be referred to as a “collimation type” for convenience. Further, since the light emitted from the DOE 106 is divergent light, the second lens group 108 has a positive focal length according to the present embodiment (e.g., see FIG. 7) may be referred to as a “divergence type”.

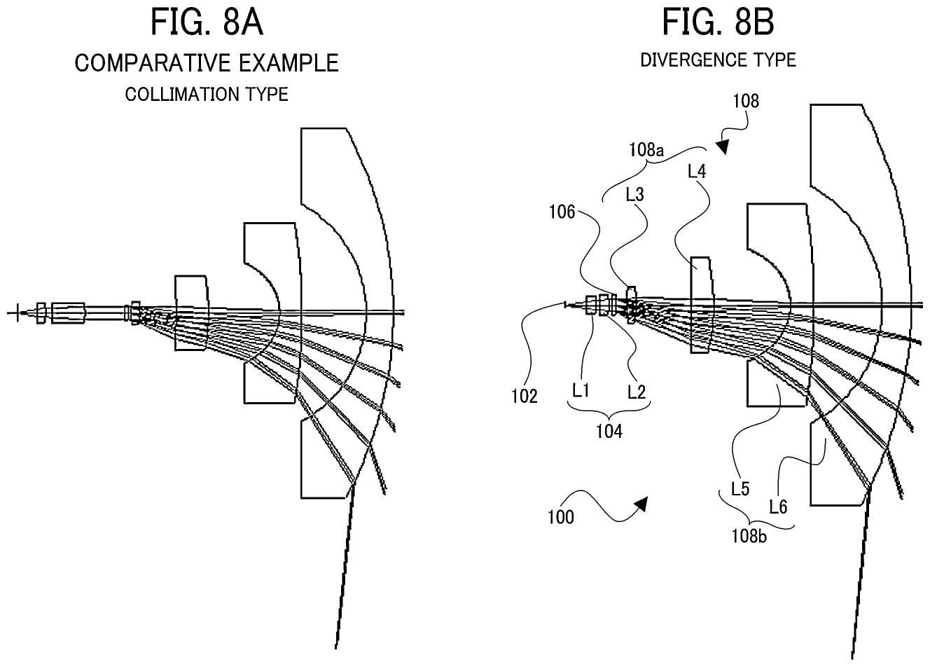

FIGS. 8A and 8B are diagrams illustrating optical paths of the collimation type and the divergence type, respectively.

In the example illustrated in FIGS. 8A and 8B, the light that has gone in the first lens group is split into the 0th to +5th order diffraction light by the DOE, the angle of view is widened by the second lens group, and the diffraction light is emitted. The 5th order diffraction light is emitted from the second lens group at an angle of 90 degrees or more of the half angle of view. In each design, various conditions such as the angle of view of the projection light and the distortion characteristic of the optical system are unified.

In addition, the light projection device 100 is designed such that the angle of view on the final optical surface (i.e., the final optical surface of the fourth lens group 108b illustrated in FIG. 8B) is greater than 90 degrees or more and 220 degrees of less in the full angle.

In the present embodiment, the first lens group 104 includes at least one positive lens. The third lens group 108a includes at least two positive lenses. The fourth lens group 108b includes at least two negative meniscus lenses. At least one of the optical surfaces of at least two negative meniscus lenses is an aspherical surface.

The light projection device 100 of the divergence type illustrated in FIG. 8B is an example of such an optical configuration.

In the example illustrated in FIG. 8B, the first lens group 104 includes a lens L1 and a lens L2. The first lens group 104 has a positive power as a whole, and at least one of the lens L1 or the lens L2 is a positive lens. The second lens group 108 has a positive power as a whole and includes a lens L3, a lens LA, a lens L5, and a lens L6. More specifically, the third lens group 108a includes the lens L3 having a positive power and the lens L4 having a positive power. The fourth lens group 108b includes the lens L5 as a negative meniscus lens and the lens L6 as a negative meniscus lens At least one of the optical surfaces of the two negative meniscus lenses (i.e., the lens L5 and the lens L6) is an aspherical surface.

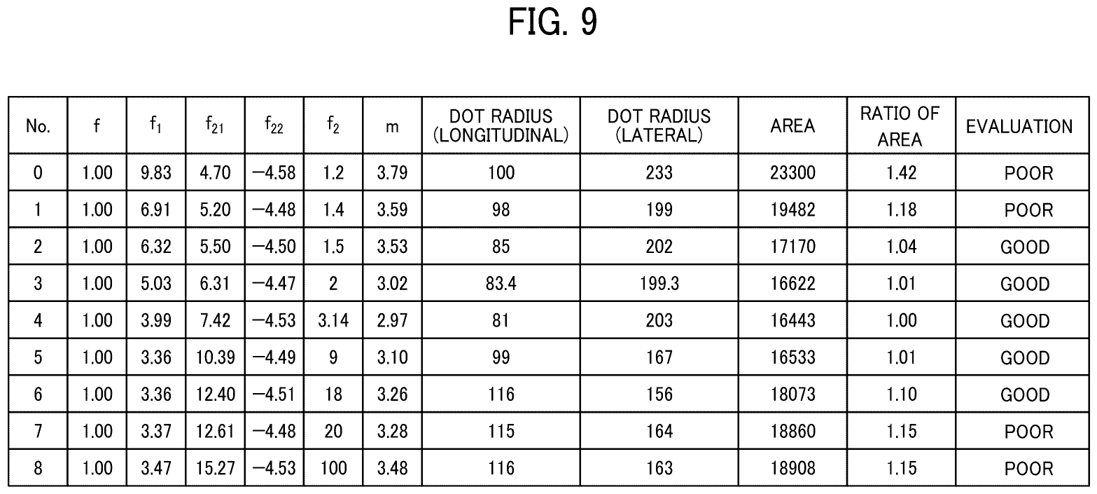

FIG. 9 is a diagram illustrating power distribution of the collimation type and the divergence type.

An optical system designed such that the second lens group 108 has a focal length f₂ of 100 mm is referred to as a collimation type, and a focal length f₂ less than 20 mm is referred to as a divergence type.

FIG. 9 represents the numerical values of the design examples different from each other in the focal length f₂. FIG. 9 represents the dot diameters, which are a longitudinal diameter and a lateral diameter, and area of dot-pattern light near the maximum angle of view when the dot-pattern light is projected to the object OB using the light projection device of each design example.

As illustrated in FIG. 9, it is understood that the smaller the focal length f₂ (i.e., the larger the positive power of the focal length f₂), the larger the focal length f₁ (i.e., the smaller the positive power of the focal length f₁) and the larger the divergence of the light that goes in the DOE. The focal length f₂₂ of the fourth lens group is substantially constant regardless of the value of the focal length f₂. Alternatively, the focal length f₂₁ of the third lens group changes according to the value of the focal length f₂.

In the example illustrated in FIG. 9, with the focal length of the fourth lens group that is a negative lens group remaining substantially invariant, the positive power of the first lens group decreases and the positive power of the third lens group increases for each design example. As a result, the dot diameter of dot-pattern light is changed.

As listed in FIG. 9, when the focal length f₂ of the second lens group 108 is 3.14, the area of dot-pattern light is minimum, and the contrast is highest. At this time, this minimum area is set as a reference (ratio=1.00). When the ratio of the area to the minimum area is +10% or less, a high contrast can be maintained, and the distance measurement accuracy is increased.

In FIG. 9, when the ratio of the area to the minimum area is +10% or less, the “EVALUATION” for the design example is “GOOD”, and when the ratio of the area to the minimum area exceeds+10%, the “EVALUATION” for the design example is “POOR”.

The range satisfying the condition “the ratio of the area to the minimum area is +10% or less” is expressed by the formula below. Since the focal length f₂₂ of the fourth lens group is substantially constant, the formula below can also express a suitable range of the positive power of the third lens group to achieve high contrast.

$$1.5 \leq {f}_{2} / f \leq 18$$

When the value of f₂/f is smaller than 1.5, the positive power of the third lens group 108a is overly large with respect to the negative power of the fourth lens group 108b. Thus, spherical aberration occurs, and the blur of the dot-pattern light becomes large.

When the value of f₂/f is larger than 18, the positive power of the third lens group 108a is overly small with respect to the negative power of the fourth lens group 108b. Thus, astigmatism that occurs in the fourth lens group 108b cannot be sufficiently cancelled by the third lens group 108a.

To achieve high contrast, the formula below may be satisfied.

1.5≤f≤f₂

As illustrated in FIG. 9, in the divergence type, when the positive power of the third lens group 108a is increased, the ratio of the focal length f₂₁ to the focal length f₂₂ changes largely with respect to the amount of change in the magnification m. As a result, the formula below is satisfied.

$${f}_{21} / {f}_{22} > - m$$

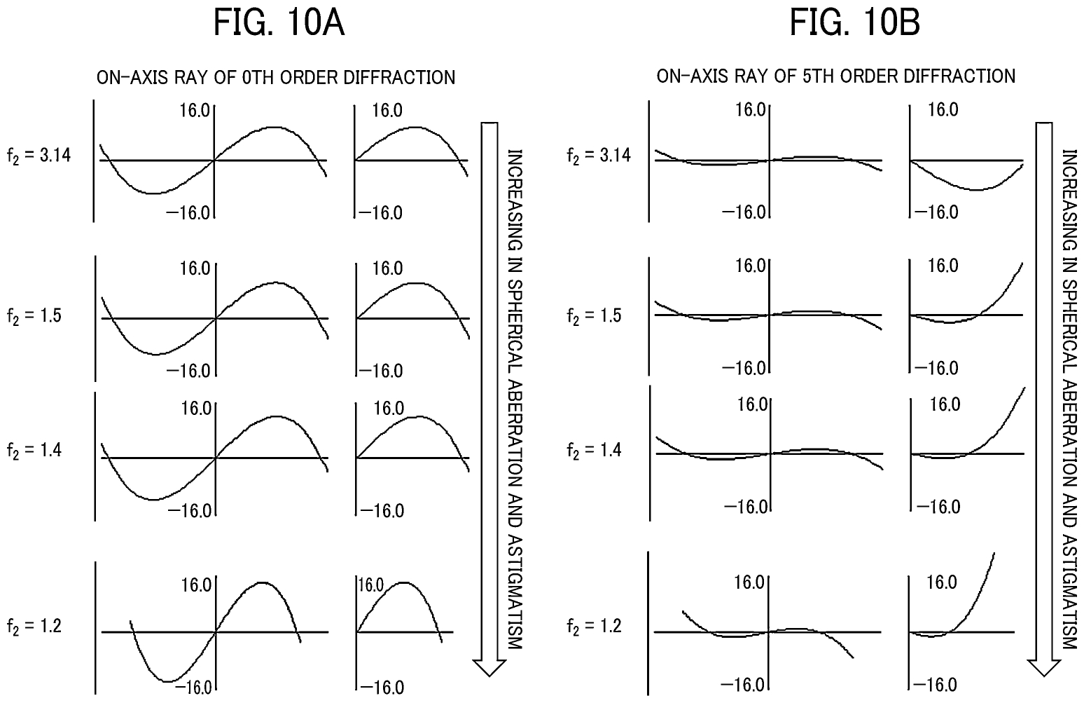

FIGS. 10A to 10D are diagrams illustrating lateral aberration in the design examples that are different from each other in the focal length f₂.

In FIGS. 10A and 10C, the lateral aberration diagrams of an on-axis ray of the 0th order diffraction (i.e., the angle of view being 0 degree) for each of the design examples having different focal lengths f₂ are illustrated. In FIGS. 10B and 10D, the lateral aberration diagrams of an on-axis ray of the 5th order diffraction (i.e., the angle of view being about 90 degrees) for each of the design examples having different focal lengths f₂ are illustrated.

In each pair of FIGS. 10A and 10C and FIGS. 10B and 10D, a lateral aberration diagram of meridional rays (i.e., a lateral aberration diagram on the left side) and a lateral aberration diagram of sagittal rays (i.e., a lateral aberration diagram on the right side) are illustrated as a set. The lateral aberration of sagittal rays is symmetric with respect to the meridional cross section. For this reason, in FIGS. 10A to 10D, the lateral aberration of sagittal ray is illustrated only on the plus side of pupil coordinates.

As illustrated in FIGS. 10A and 10C, in any of the design examples, the on-axis ray of the 0th order diffraction (i.e., the angle of view being 0 degrees) is well collected. On the other hand, the convergence of the on-axial ray of the 5th order diffraction (i.e., the angle of view being about 90 degrees) varies greatly depending on the design example.

For convenience, a design example in the case where the focal length f₂ is “n” is referred to as a “design example [n]”.

In the design example [3.14], the light emitted from the light projection device 100 preferably forms an image in the meridional cross section. Astigmatism occurs in the sagittal direction. However, in the sagittal direction, the principal ray, the upper ray, and the lower ray are imaged at the same position. In other words, astigmatism is satisfactorily corrected.

In the design example in which the focal length f₂ is small (e.g., design example [1.2]), spherical aberration occurs with respect to the upper ray and the lower ray in the meridional cross section. A large amount of astigmatism occurs in the sagittal direction. Thus, a large amount of blur due to spherical aberration occurs, and a large amount of astigmatism also occurs, resulting in a decrease in contrast.

In the design example in which the focal length f₂ is large (e.g., design example) [100], spherical aberration is preferably corrected in the meridional cross section. On the other hand, a large amount of astigmatism occurs in the sagittal direction. For example, the dot-pattern light is projected in an enlarged manner in the sagittal direction due to the occurrence of astigmatism, and the contrast is decreased.

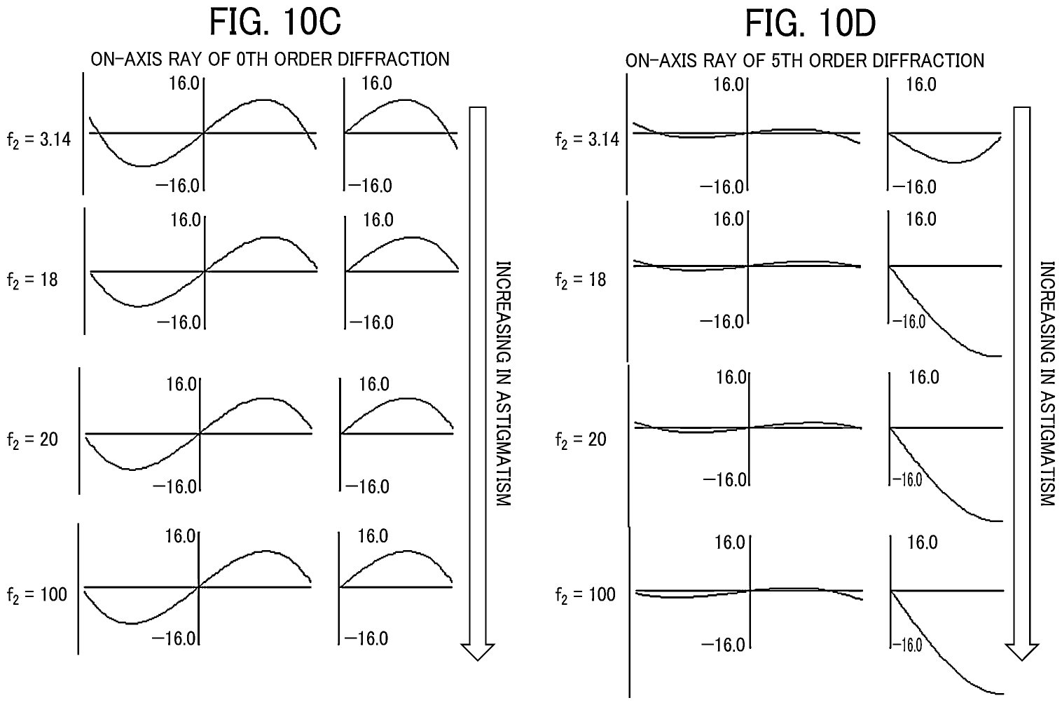

FIG. 11 is a diagram illustrating dot-pattern light in design examples in which the focal length f₂ is different from each other. In FIG. 11, three design examples are illustrated, and the these focal lengths f₂ are 1.2 mm, 3.14 mm, and 100 mm, respectively.

FIG. 11 is a diagram illustrating a change of the dot-pattern light according to a change of the focal length f₂ (i.e., the lateral aberration change) as a comparison. The dot-pattern light is at the half angle of view of 90 degrees.

When the focal length f₂ is overly short (i.e., if the positive power of the second lens group 108 is overly large), a large spherical aberration occurs in the meridional cross section, and astigmatism occurs in the sagittal direction. Thus, as indicated in the design example [1.2], for example, the dot-pattern light is blurred as a whole.

When the focal length f₂ is overly long (i.e., if the positive power of the second lens group 108 is overly small), a large amount of astigmatism occurs in the sagittal direction, and the dot-pattern light spreads in the sagittal direction as indicated in the design example [100].

As illustrated in FIG. 11, the design example [3.14] has a preferable aberration.

According to the present embodiment, there is no restriction that the second lens group 108 is designed as an afocal-focal converter. Thus, the degree of freedom in design is higher than that in the related art.

Three numerical examples of the light projection device 100 according to the present embodiment will be described below. The light projection device 100 for each numerical example includes the configuration illustrated in FIG. 8B. In other words, the first lens group 104 includes the lens L1 and the lens L2. The first lens group 104 has a positive power as a whole, and at least one of the lens L1 or the lens L2 is a positive lens. The second lens group 108 has a positive power as a whole and includes a lens L3, a lens L4, a lens L5, and a lens L6. More specifically, the third lens group 108a includes the lens L3 having a positive power and the lens LA having a positive power. The fourth lens group 108b includes the lens L5 as a negative meniscus lens and the lens L6 as a negative meniscus lens At least one of the optical surfaces of the two negative meniscus lenses (i.e., the lens L5 and the lens L6) is an aspherical surface.

The symbols used in the numerical examples will be described below.
f: focal length of the overall light projection device 100 (mm)
f₁: focal length of the first lens group 104 (mm)
f₂: focal length of the second lens group 108 (mm)
f₂₁: focal length of the third lens group 108a (mm)
f₂₂: focal length of the fourth lens group 108b (mm)
Y′: height of light source (mm)
θ: angle of view of the ray emitted from the second lens group 108 (degree)
m: magnification (=θ/θ₀)
θ₀ is the angle of view (degree) on the emitting surface of the DOE 106.
R: radius of curvature or paraxial radius of curvature of each surface of the optical element (mm)
D: thickness of optical element on the optical axis or the distance between the optical elements (mm)
Nd: refractive index at the d-line (wavelength: 587.562 nanometers (nm))
νd: Abbe number of the d-line
d: diffraction lattice constant (mm)

The following is an equation expressing an aspherical shape.

$$Z = {Ch}^{2} / \{ 1 + √ ( ( 1 - ( 1 + K ) {C}^{2} {h}^{2} ) \} + {A}_{4} \cdot {h}^{4} + {A}_{6} \cdot {h}^{6} + {A}_{8} \cdot {h}^{8} + {A}_{10} \cdot {h}^{10} ) ,$$

where Z is the amount of the sag,
C is the paraxial curvature (1/R), in which R is the radius of curvature on an aspherical element that is the paraxial radius of curvature on the optical axis,
h is the height from the optical axis (mm),
K is the conic coefficient, and
A₄, A₆, A₈, and A₁₀ are fourth or higher order aspherical surface coefficients. In the following description, “e” and the upper right number of “e” included in the aspherical surface coefficients represent the base of ten (10) and the exponent, respectively.

### Numerical Example 1

A specific numerical configuration of the light projection device 100 according to Numerical Example 1 is listed in Table 1. The focal length f of the overall light projection device 100 is 1.00 mm. The focal length f₂ of the second lens group 108 is 3.14 mm. The F number is 0.17. The light source height Y′ is 0.3 mm. The angle of view θ (full angle of view) is 200 degrees.

TABLE 1

| Surface No. | R | D | Nd | νd |
|---|---|---|---|---|
| 1 | ∞ | 1.85 | | |
| 2 | −6 | 0.8 | 1.821145 | 24.0583 |
| 3 | ∞ | 0.3 | | |
| 4 | −6 | 0.8 | 1.821145 | 24.0583 |
| 5 | ∞ | 0.3 | | |
| 6* | ∞ | 0.3 | 1.5168 | 64.1673 |
| 7 | ∞ | 0.96 | | |
| 8 | 12.58 | 0.8 | 1.821145 | 24.0583 |
| 9 | −12.58 | 4.74 | | |
| 10 | ∞ | 2 | 1.84666 | 23.7779 |
| 11* | −18.8441 | 6.65 | | |
| 12* | −4.62853 | 2 | 1.661342 | 20.3729 |
| 13 | −233.895 | 6 | | |
| 14 | −11.641 | 2.5 | 1.84666 | 23.7779 |
| 15 | −37.197 | | | |

The sixth surface is the emitting surface of the DOE 106. The diffraction lattice constant d of the DOE 106 is 0.0092 mm.

The eleventh surface is an aspherical surface. The conical coefficient K of the eleventh surface and the respective aspherical coefficients are listed below.

$$K = - 1.3587$$

$${A}_{4} = - 0.0011568$$

$${A}_{6} = - 4.5931 e - 05$$

$${A}_{8} = - 2.4547 e - 07$$

The twelfth surface is an aspherical surface. The conical coefficient K of the twelfth surface and the respective aspherical coefficients are listed below.

$$K = 10 \text{.00}$$

$${A}_{4} = - 0.00021 \; 622$$

$${A}_{6} = 2.0901 e - 06$$

$${A}_{8} = - 4.3773 e - 09$$

The numerical values of the conditional expressions in Numerical Example 1 are listed below.

$${f}_{2} / f = 3 \text{.14}$$

$${f}_{21} / {f}_{22} ( = - 1.63 ) > - m ( = - 2.97 )$$

### Numerical Example 2

A specific numerical configuration of the light projection device 100 according to Numerical Example 2 is listed in Table 2. The focal length f of the overall light projection device 100 is 1.00 mm. The focal length f₂ of the second lens group 108 is 1.5 mm. The F number is 0.17. The light source height Y′ is 0.3 mm. The angle of view θ (full angle of view) is 200 degrees.

TABLE 2

| Surface No. | R | D | Nd | νd |
|---|---|---|---|---|
| 1 | ∞ | 1.85 | | |
| 2 | −3.99369 | 0.8 | 1.821145 | 24.0583 |
| 3 | ∞ | 0.3 | | |
| 4 | 16.82465 | 0.8 | 1.821145 | 24.0583 |
| 5 | ∞ | 1.023489 | | |
| 6* | ∞ | 0.3 | 1.5168 | 64.1673 |
| 7 | ∞ | 0 | | |
| 8 | 20.68694 | 0.3 | 1.821145 | 24.0583 |
| 9 | −10.6912 | 0.8 | | |
| 10 | 24.26486 | 1.289491 | 1.84666 | 23.7779 |
| 11* | −11.705 | 3 | | |
| 12* | −4.62853 | 13.9871 | 1.661342 | 20.3729 |
| 13 | −233.895 | 2 | | |
| 14 | −11.6135 | 6.049921 | 1.84666 | 23.7779 |
| 15 | −37.9339 | 2.5 | | |

The sixth surface is the emitting surface of the DOE 106. The diffraction lattice constant d of the DOE 106 is 0.0110 mm.

The eleventh surface is an aspherical surface. The conical coefficient K of the eleventh surface and the respective aspherical coefficients are listed below.

$$K = - 1.3587$$

$${A}_{4} = - 0.0011568$$

$${A}_{6} = - 4.5931 e - 05$$

$${A}_{8} = - 2.4547 e - 07$$

The twelfth surface is an aspherical surface. The conical coefficient K of the twelfth surface and the respective aspherical coefficients are listed below.

$$K = 10 \text{.00}$$

$${A}_{4} = - 0.00021 \; 622$$

$${A}_{6} = 2.0901 e - 06$$

$${A}_{8} = - 4.3773 e - 09$$

The numerical values of the conditional expressions in Numerical Example 2 are listed below.

$${f}_{2} / f = 1.5$$

$${f}_{21} / {f}_{22} ( = - 1.22 ) > - m ( = - 3.53 )$$

### Numerical Example 3

A specific numerical configuration of the light projection device 100 according to Numerical Example 3 is listed in Table 3. The focal length f of the overall light projection device 100 is 1.00 mm. The focal length f₂ of the second lens group 108 is 18 mm. The F number is 0.17. The light source height Y′ is 0.3 mm. The angle of view θ (full angle of view) is 200 degrees.

TABLE 3

| Surface No. | R | D | Nd | νd |
|---|---|---|---|---|
| 1 | ∞ | 1.85 | | |
| 2 | −3.64726 | 0.8 | 1.821145 | 24.0583 |
| 3 | ∞ | 0.3 | | |
| 4 | −5.85342 | 2.814914 | 1.821145 | 24.0583 |
| 5 | ∞ | 0.3 | | |
| 6* | ∞ | 0.3 | 1.5168 | 64.1673 |
| 7 | ∞ | 0 | | |
| 8 | 8.386353 | 0.3 | 1.821145 | 24.0583 |
| 9 | 16.30511 | 0.8 | | |
| 10 | −30.1543 | 3.167431 | 1.84666 | 23.7779 |
| 11* | −11.625 | 2 | | |
| 12* | −4.62853 | 6.906259 | 1.661342 | 20.3729 |
| 13 | −233.895 | 2 | | |
| 14 | −11.3124 | 5.961396 | 1.84666 | 23.7779 |
| 15 | −35.4893 | 2.5 | | |

The sixth surface is the emitting surface of the DOE 106. The diffraction lattice constant d of the DOE 106 is 0.0101 mm.

The eleventh surface is an aspherical surface. The conical coefficient K of the eleventh surface and the respective aspherical coefficients are listed below.

$$K = - 1.3587$$

$${A}_{4} = - 0.0011568$$

$${A}_{6} = - 4.5931 e - 05$$

$${A}_{8} = - 2.4547 e - 07$$

The twelfth surface is an aspherical surface. The conical coefficient K of the twelfth surface and the respective aspherical coefficients are listed below.

$$K = 10 \text{.00}$$

$${A}_{4} = - 0.00021 \; 622$$

$${A}_{6} = 2.0901 e - 06$$

$${A}_{8} = - 4.3773 e - 09$$

The numerical values of the conditional expressions in Numerical Example 3 are listed below.

$${f}_{2} / f = 18$$

$${f}_{21} / {f}_{22} ( = - 2.75 ) > - m ( = - 3.28 )$$

In any of Numerical Examples 1 to 3, various conditional expressions are satisfied. As described above, aberration can be corrected satisfactorily, and the area of the dot-pattern light can be prevented from spreading even in a region in which the angle from the optical axis is large. Since the area of the dot-pattern light is prevented from spreading, the brightness of the dot-pattern light can be maintained, and the contrast is increased. As a result, the accuracy of the distance measurement is increased.

The above is a description of exemplary embodiments of the present disclosure. The embodiments of the present disclosure are not limited to those described above, and various modifications are possible within the scope of the technical idea of the present disclosure. For example, the embodiments of the present disclosure also include contents obtained by appropriately combining the embodiments of the present disclosure explicitly described in the specification or the obvious embodiments.

The DOE 106 is an example of an optical element that obtains pattern light from the laser beam that goes in the DOE 106 through the first lens group 104. However, a mirror can be used instead of the DOE 106.

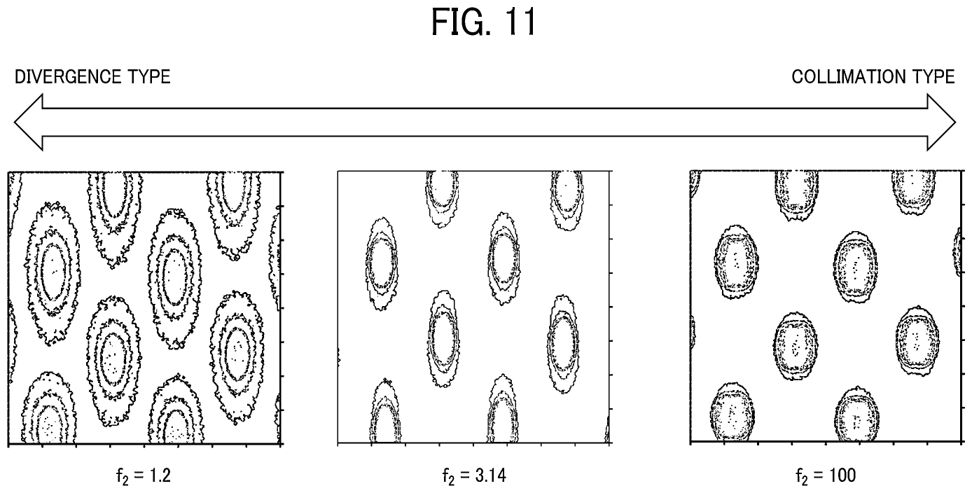

FIG. 12 is an optical configuration of the light projection device 100 according to a modification.

As illustrated in FIG. 12, in the light projection device 100 according to the comparative example, a mirror M is disposed between the first lens group 104 and the second lens group 108. The controller 140 controls the mirror M to drive. For example, when the mirror M is rotated around an axis perpendicular to the surface of the drawing in FIG. 12, the laser beam that goes in the mirror M through the first lens group 104 is sequentially bent to an emission angle corresponding to the angle of the 0th, 1st, 2nd, . . . , n-th order diffraction light in the above-described embodiment, for example, and sequentially projected to the object OB as dot-pattern light.

In FIG. 12, for example, multiple light sources are arranged in a direction perpendicular to the surface of the drawing, the mirror M is rotated around the axis described above while the multiple light sources are blinking. Accordingly, the dot-pattern light having a lattice shape can be projected to the object OB.

As described above, the mirror M is an example of a mirror that guides the laser beam that goes in the mirror M through the first lens group 104 to the object OB as pattern light.

The light projection-and-reception apparatus 2 according to the present embodiment includes the light projection device 100 and the ToF light receiver 120 on both sides of the apparatus as illustrated in FIG. 4 in order to obtain the angle of view over the entire circumference of the apparatus, but is not limited to this configuration.

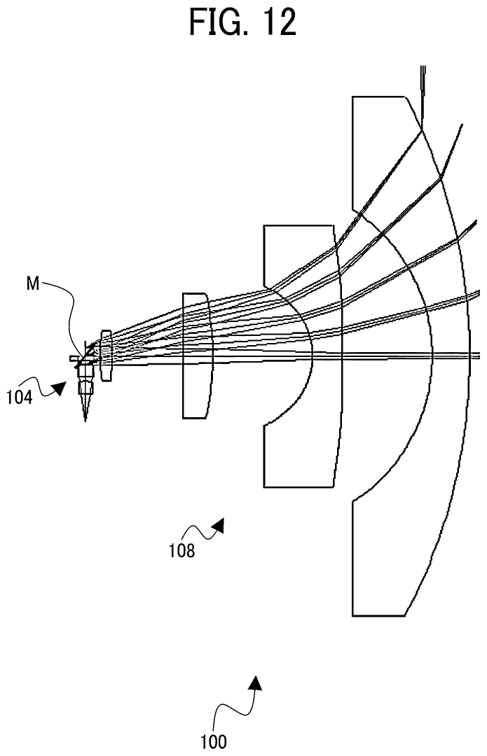

FIG. 13 is a diagram illustrating another example of the configuration of optical components of the light projection-and-reception apparatus 2. The light projection-and-reception apparatus 2 illustrated in FIG. 13 includes a light projection device 100 and a ToF light receiver 120 on one surface of the light projection-and-reception apparatus 2. Further, the light projection-and-reception apparatus 2 may include an instrument 200 such as a tripod that functions as a support, and a rotator 220 that is a rotation table rotated by an electric motor disposed over the instrument 200. In this case, the light projection-and-reception apparatus 2 obtains a distance image of the entire circumference while changing the imaging direction by rotating the apparatus itself by the rotator 220.

The rotation control unit of the light projection-and-reception apparatus 2 has a predetermined rotation pattern when the rotation control unit controls the rotator 220. For example, the rotation control unit of the light projection-and-reception apparatus 2 controls the light projection-and-reception operation to the entire circumference of the apparatus in multiple times by the rotation pattern of (1) rotation by a predetermined distance, (2) light projection-and-reception operation after stopping the rotation, (3) rotation by a predetermined distance, and (4) light projection-and-reception operation after stopping the rotation.

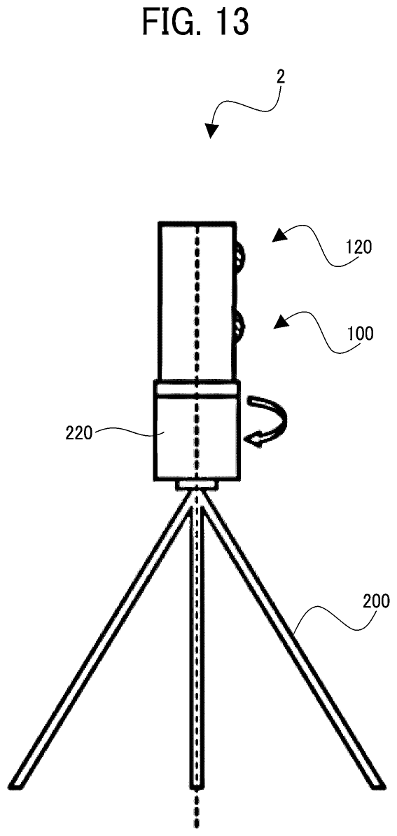

FIG. 14 is a block diagram of a configuration of a three-dimensional shape generation system 4 according to a second embodiment.

As illustrated in FIG. 14, the three-dimensional shape generation system 4 includes a light projection-and-reception apparatus 2 and a computing device 3A. The three-dimensional shape generation system 4 is obtained by adding a generation processing unit 32 to the computing device 3 of the distance measurement system 1 illustrated in FIG. 1.

The computing device 3A includes a generation processing unit 32 that generates three-dimensional shape information based on the obtained three-dimensional point group in addition to the computing unit 31. The three-dimensional shape information is information indicating a three-dimensional shape of an object that can be processed by a computer. The information indicating the three-dimensional shape is information that can geometrically specify the three-dimensional shape. For example, when the information expresses a sphere, the center coordinate and the radius of the sphere correspond to the information indicating three-dimensional shape, or when the information expresses a polyhedron (polygon), the coordinate points of the vertices of the polyhedron correspond to the information indicating the three-dimensional shape. The three-dimensional shape information may include information related to the color or material of the object in addition to information indicating the three-dimensional shape of the object.

The storage unit 33 of the computing device 3A includes a setting information management database (DB) 301, a storage processing management DB 302, a point group management DB 303, and a three-dimensional shape management DB 304.

The setting information management DB 301 stores and manages various information. The storage processing management DB 302 stores and manages various processing programs for generating a three-dimensional shape. The point group management DB 303 stores and manages the three-dimensional point group information obtained by the distance measurement system. The three-dimensional shape management DB 304 stores and manages three-dimensional shape information.

The setting information management DB 301 includes a setting information management table. The setting information management table is a table for managing the three-dimensional point group data for generating a three-dimensional shape, and the execution order and processing mode of the generation processing (i.e., three-dimensional shape generation processing) for generating a three-dimensional shape. In the setting information management table, the file name of the three-dimensional point group data, and the execution order and processing mode of the three-dimensional shape generation processing are managed in association with each other.

The three-dimensional shape generation processing includes, for example, registration processing, noise removal processing, segmentation processing, and modeling processing.

The registration processing is processing for converting multiple three-dimensional point groups into one unified three-dimensional point group. The noise removal processing is processing for removing an unnecessary point group from the three-dimensional point group.

The segmentation processing is processing that labels a specific point group in the three-dimensional point group so as to distinguish the specific point group from other point groups, and differently labels each of the multiple specific point groups so as to distinguish the multiple specific point groups from each other. The segmentation processing may be performed together with the clustering processing that groups point groups having a short distance among the labeled point groups.

In the modeling processing, the specific point group in the three-dimensional point group corresponds with the three-dimensional model shape and replaces the specific point group with the model shape. The three-dimensional model shape is a model such as a template or a template used for generating three-dimensional shape information from a three-dimensional point group.

The processing mode includes manual processing that executes a part or the whole of the three-dimensional shape information generation processing based on an operation input from a user without executing storage processing, automatic processing that executes a part or the whole of the three-dimensional shape information generation processing based on storage processing stored in advance without depending on an operation input, and mixed processing that executes a part or the whole of the three-dimensional shape information generation processing by mixing the manual processing and the automatic processing.

The generation processing unit 32 receives an input operation from a user. The input operation includes, for example, an operation of setting point group setting information indicating a three-dimensional point group to be processed and an operation of setting processing setting information indicating an execution order and a processing mode of each processing in the three-dimensional shape information generation process.

The generation processing unit 32 executes the three-dimensional shape information generation processing set by the input operation. The processing mode of the generation processing in the processing setting information is used as a search key to search the point group management DB 303, and the generation processing unit 32 reads out the processing program associated with the processing setting information. The processing mode of the generation processing in the processing setting information is used as a search key to search the storage processing management DB 302, and the generation processing unit 32 reads out the processing program associated with the processing setting information. The generation processing unit 32 generates the three-dimensional shape information based on the three-dimensional point group data, the processing program, and the execution order and the processing mode of the processing setting information read from the storage unit 33.

When the processing mode includes the manual processing and the mixed processing, the generation processing unit 32 generates an operation screen that receives an operation input for generating the three-dimensional shape information, displays the operation screen on a display unit (e.g., a display), and receives a predetermined input operation from the user on the displayed operation screen. The input operation includes an operation input that executes processing in which the manual processing mode is selected in the three-dimensional shape information generation processing. The generation processing unit 32 generates the three-dimensional shape information based on the operation input information by the input operation.

The generation processing unit 32 converts the generated three-dimensional shape information into a CAD format, and stores the converted three-dimensional shape information in the three-dimensional shape management DB 304, or an external recording medium.

In the three-dimensional shape generation system according to the present embodiment, the three-dimensional shape information can be generated based on the point group obtained by the distance measurement system. As a result, the three-dimensional modeling of existing buildings in the fields of architecture, construction, or civil engineering can be facilitated and used in a building information modeling (BIM)/construction information modeling (CIM).

The generation processing unit 32 is not limited to be included in the computing device 3A including the computing unit 31A, and may be included in, for example, another terminal device connected to the computing device 3A by wired communication or wireless communication or a server located on a cloud. The three-dimensional shape generation processing may be executed by multiple devices (e.g., the computing device 3A and a server connected to the computing device 3A).

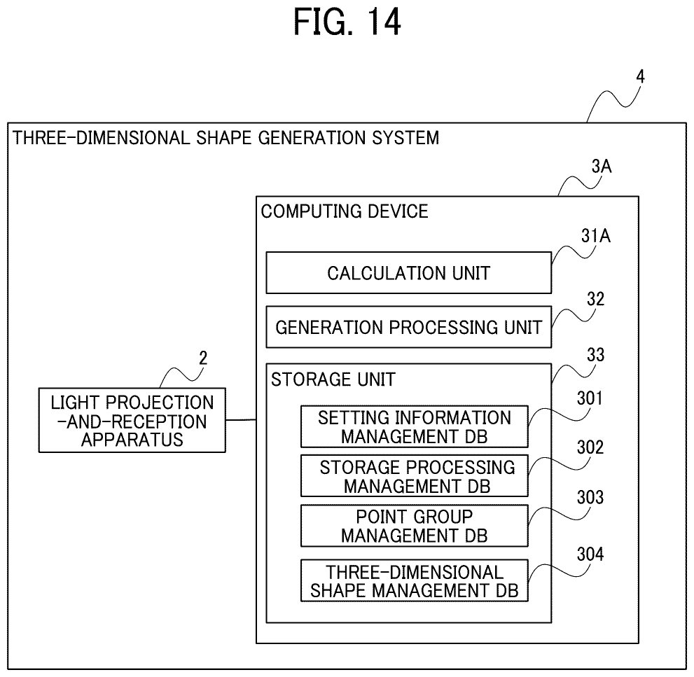

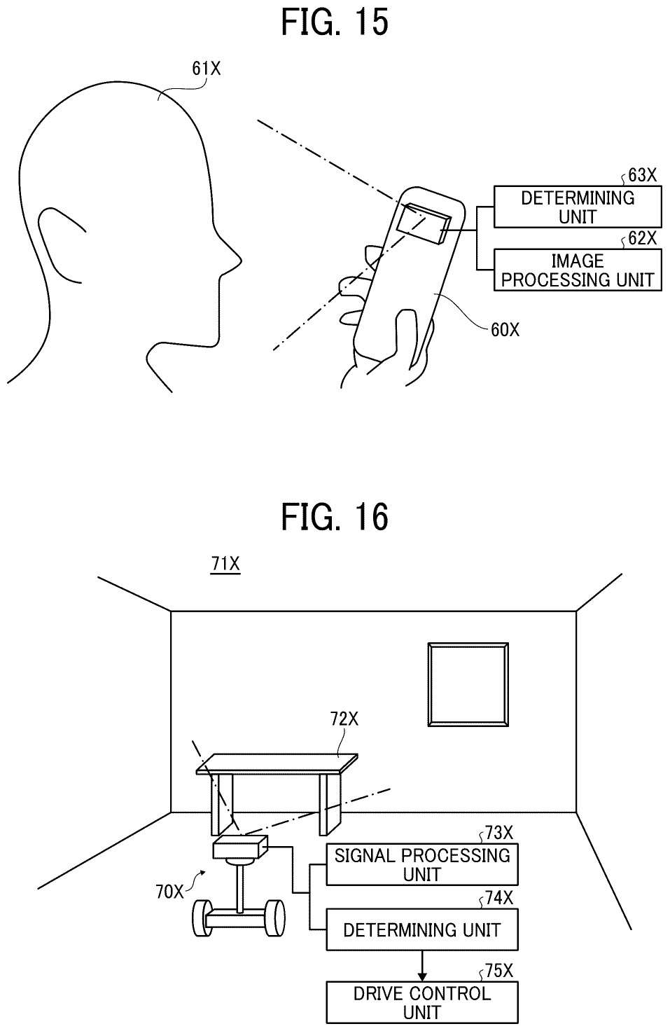

Application examples in which the distance measurement system 1 is used in various detection systems will be described with reference to FIGS. 15 and 16. Each of the detection systems in these application examples have the functional block described later in addition to the distance measurement system 1. In FIGS. 15 and 16, the functional blocks such as a determination unit included in the detection system are illustrated outside the detection system for convenience of illustration. The various detection systems illustrated in FIGS. 15 to 16 include a control unit to which information from the distance measurement system 1 is input and that controls the various detection systems based on the information from the distance measurement system 1.

FIG. 15 is a diagram illustrating an example of a shape measurement system as a detection system, and an application example in which the distance measurement system 1 is used for user authentication of an electronic apparatus will be described. The portable information terminal 60X of an electronic device has a user authentication function. The authentication function may be implemented by dedicated hardware, or may be implemented by a central processing unit (CPU) that controls the portable information terminal 60X that executes a program such as a read-only memory (ROM).

When the user is authenticated, the light is projected from the light source device of the distance measurement system 1 mounted on the portable information terminal 60X toward the user 61X who uses the portable information terminal 60X. The light reflected by the user 61X and the surroundings of the user is received by the light reception element of the distance measurement system 1, and the image processing unit 62X generates image data (i.e., performs imaging). A determination unit 63X determines the degree of coincidence between image information obtained by imaging the user 61X by the distance measurement system 1 and previously registered user information, and determines whether the user is a registered user. Specifically, the shape (e.g., contour or unevenness) of the face, ears, or head of the user 61X can be measured and used as the user information.

In the application example illustrated in FIG. 15, in terms of the detection of the user 61x by the distance measurement system 1, the detection accuracy can be increased, which is the same effect as that of the distance measurement system 1. In particular, since the information of the user 61X can be detected in a wide range by projecting the light from the light projection device in a wide angle, the amount of information for recognizing the user is increased as compared with the case where the detection range is narrow, and thus the recognition accuracy can be increased.

Although FIG. 15 is a diagram illustrating an example in which the distance measurement system 1 is mounted on the portable information terminal 60X, the user authentication using the distance measurement system 1 can be used for a stationary personal computer, an office automation device such as a printer, or a security system of a building. The function is not limited to the authentication function of an individual, and can also be used for scanning a three-dimensional shape such as a face. In this case, the distance measurement system 1 that projects light at a wide angle can also implement high-precision scanning.

FIG. 16 is a diagram illustrating an example of an autonomous moving system of a mobile object to which a distance measurement system according to the first embodiment of the present disclosure is applied. In the example illustrated in FIG. 16, the distance measurement system 1 is used to sense an object outside the moving body 70X. The moving body 70X is a moving body of autonomous moving type that can automatically move while recognizing a surrounding situation.

A distance measurement system 1 is mounted on the moving body 70X, and the distance measurement system 1 projects the light in the moving direction of the moving body 70X and in the surroundings around the direction. In a room 71X that is a moving area for the moving body 70X, a desk 72X is installed in the moving direction of the moving body 70X. Of the light projected from the light source device of the distance measurement system 1 mounted on the moving body 70X, the light reflected from the desk 72X and its surroundings is received by the light reception element of the distance measurement system 1, and the electric signal that has been photoelectrically converted is sent to the signal processing unit 73X. The signal processing unit 73X calculates information on the layout of the room 71X, such as the distance to the desk 72X, the position of the desk 72X, and the surroundings other than the desk 72X, based on the electric signal sent from the light reception element. The determining unit 74X determines the moving path and the moving speed of the moving body 70X based on the calculated information, and the operation control unit 75X controls the running of the moving body 70X (e.g., the operation of the motor as the driving source) based on the determination result of the determining unit 74X.

In the application example illustrated in FIG. 16, in terms of the detection of the layout of the room 71X by the distance measurement system 1, the detection accuracy can be increased, which is the same effect as the distance measurement system 1. In particular, since the information of the room 71X can be detected in a wide range by projecting the light from the light projection device in a wide angle, a large amount of information can be obtained as compared with the case where the detection range is narrow. As a result, the accuracy of the autonomous moving of the moving body 70X can be increased.

Although FIG. 16 is a diagram illustrating an example in which the distance measurement system 1 is mounted on a moving body 70X that is an autonomous type and moves in the room 71X, the distance measurement system 1 may be applied to an autonomous moving vehicle moving in an outdoor area (referred to as self-driving vehicle). The present embodiment can be also applied to a driving assist system for a moving body such as an automobile driven by a driver, instead of the autonomous driving. In this case, the surroundings of the moving body is detected using the distance measurement system 1, and the driver's driving can be assisted depending on the detected surroundings.

In addition to the above, the distance measurement system 1 may be applied to an article inspection system in, for example, a factory. Specifically, the state of each article is determined by the determining unit of the article inspection system based on the information obtained by the distance measurement system 1.

Further, the distance measurement system 1 may be applied to the operation control of the movable apparatus. A multi-joint arm as a movable device includes multiple arms connected by multiple joints that are bendable and include a hand part at the tip of the multi-joint art. The multi-joint arm is used, for example, in an assembly line of a factory, and grasps an object by the hand part at the time of inspection transportation, and assembly of the object. The distance measurement system 1 detects the object and the surroundings of the object. The determination unit of a movable device determines various information relating to the object, such as the distance to the object, the shape of the object, the position of the object, and the positional relation between multiple objects when the multiple objects exist, on the basis of the information obtained by the distance measurement system 1. Accordingly, the drive control unit controls the multi-joint arm operation based on the determination result of the determination unit.

The distance measurement system 1 may be applied to a driving assist system for a moving body such as a vehicle. The distance measurement system 1 mounted on a vehicle detects a driver that drives the vehicle and the surroundings of the driver, and a determination unit of a driving assist system determines information such as the face (facial expression) and posture of the driver based on the information obtained by the distance measurement system 1. The control unit appropriately assists driving depending on the driver's situation based on the determination result by the determination unit.

The shape measurement system, the moving body, the article inspection system, the movable device, and the driving assist system are all examples of the detection system. The distance measuring system 1 according to the present embodiment can project the pattern light to the object in a wide angle while preventing the light from spreading the area of the pattern light. Accordingly, the detection system to which the distance measurement system 1 is applied can achieve high-precision detection in a wide range.

Aspects of the present disclosure are as follows.

### First Aspect

A light projection device includes a light source to emit light and an optical system to project pattern light to an object. The pattern light is obtained from the light emitted from the light source. The optical system includes a first lens group on which the light emitted from the light source is incident, an optical element to form the pattern light from the light passing through the first lens group and incident on the optical element, and a second lens group on which the pattern light emitted from the optical element is incident. The first lens group has a positive power, and the second lens group has a positive power. The light projection device includes a third lens group having a positive power, and a fourth lens group having a negative power. The third lens group and the fourth lens group are arranged in order of the third lens group and the fourth lens group from the optical element.

### Second Aspect

In the light projection device according to the first aspect, formulae bellow are satisfied,

$${f}_{1} > 0 , and 1.5 \leq {f}_{2} / f \leq 18 ,$$

where
f (mm) is a focal length of the optical system as a whole,
f₁ (mm) is a focal length of the first lens group, and
f₂ (mm) is a focal length of the second lens group.

### Third Aspect

In the light projection device according to the first aspect, the optical element includes a diffraction optical element to form the pattern light from the light passing through the first lens group and incident on the optical element.

### Fourth Aspect

In the light projection device according to the third aspect, the following formula is satisfied,

$${f}_{21} / {f}_{22} > - m ,$$

where
f₂₁ is a focal length of the third lens group,
f₂₂ is a focal length of the fourth lens group, and
m is a ratio of an angle of view on a final optical surface in the optical system to an angle of view of an emitting surface of the optical element.

### Fifth Aspect

In the light projection device according to the first aspect, the first lens group includes at least one positive lens, the third lens group includes at least two positive lenses, the fourth lens group includes at least two negative meniscus lenses having optical surfaces, and at least one optical surface of the optical surfaces of the two negative meniscus lenses is an aspherical surface.

### Sixth Aspect

In the light projection device according to the first aspect, a final optical surface of the optical system has an angle of view of 90 degrees or more and 220 degrees or less at a full angle.

### Seventh Aspect

In the light projection device according to the first aspect, the following formula is satisfied,

1.5f≤f₂,
where
f (mm) is an overall focal length of the optical system, and
f₂ (mm) is a focal length of the second lens group.

### Eighth Aspect

In the light projection device according to the first aspect, the optical element includes a mirror to guide the light to the object as the pattern light, the light passing through the first lens group and incident on the mirror.

### Ninth Aspect

A light projection-and-reception apparatus includes the light projection device according to any one of the first aspect to eighth aspects, to project the pattern light to the object, a light receiver to receive a reflection light reflected from the object to which the pattern light is projected, and a controller to control the light source and the light receiver.

### Tenth Aspect

A distance measurement system includes the light projection-and-reception apparatus according to the ninth aspect and a distance calculator to calculate a distance to the object based on an output of the light received by the light receiver.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, ASICs (“Application Specific Integrated Circuits”), FPGAs (“Field-Programmable Gate Arrays”), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

1. A light projection device comprising:
a light source to emit light; and
an optical system to project pattern light to an object, the pattern light obtained from the light emitted from the light source, the optical system including:
a first lens group on which the light emitted from the light source incident, the first lens group having a positive power;
an optical element to form the pattern light from the light passing through the first lens group and incident on the optical element; and
a second lens group on which the pattern light emitted from the optical element incident, the second lens group having a positive power,
wherein the second lens group includes:
a third lens group having a positive power; and
a fourth lens group having a negative power, and
the third lens group and the fourth lens group are arranged in order of the third lens group and the fourth lens group from the optical element.

2. The light projection device according to claim 1,
wherein formulae bellow are satisfied,
$${f}_{1} > 0 , and$$
$$1.5 \leq {f}_{2} / f \leq 18 ,$$
where
f (mm) is a focal length of an overall optical system,
f₁ (mm) is a focal length of the first lens group, and
f₂ (mm) is a focal length of the second lens group.

3. The light projection device according to claim 1,
wherein the optical element includes a diffraction optical element to form the pattern light from the light passing through the first lens group and incident on the optical element.

4. The light projection device according to claim 3,
wherein a formular below is satisfied,
$${f}_{21} / {f}_{22} > - m ,$$
where
f₂₁ is a focal length of the third lens group,
f₂₂ is a focal length of the fourth lens group, and
m is a ratio of an angle of view on a final optical surface in the optical system to an angle of view of an emitting surface of the optical element.

5. The light projection device according to claim 1,
wherein the first lens group includes at least one positive lens,
the third lens group includes at least two positive lenses,
the fourth lens group includes at least two negative meniscus lenses having optical surfaces, and
at least one optical surface of the optical surfaces of the two negative meniscus lenses is an aspherical surface.

6. The light projection device according to claim 1,
wherein a final optical surface of the optical system has an angle of view of 90 degrees or more and 220 degrees or less at a full angle.

7. The light projection device according to claim 1,
wherein a formula below is satisfied,
1.5≤f≤f₂,
where
f (mm) is an overall focal length of the optical system, and
f₂ (mm) is a focal length of the second lens group.

8. The light projection device according to claim 1,
wherein the optical element includes a mirror to guide the light to the object as the pattern light, the light passing through the first lens group and incident on the mirror.

9. A light projection-and-reception apparatus comprising:
the light projection device according to claim 1 to project the pattern light to the object;
a light receiver to receive a reflection light reflected from the object to which the pattern light is projected; and
circuitry configured to control the light source and the light receiver.

10. A distance measurement system comprising:
the light projection-and-reception apparatus according to claim 9; and
circuitry configured to calculate a distance to the object based on an output of the light received by the light receiver.
